(19) United States
(12) Patent Application Publication
(10) Pub. No.: US 2023/0286142 A1
(43) Pub. Date: Sep. 14, 2023

(54) ROBOT TEACHING CONTROL METHOD, ROBOT TEACHING APPARATUS, AND ROBOT SYSTEM

(71) Applicant: SEIKO EPSON CORPORATION, Tokyo (JP)

(72) Inventor: Kaoru TAKEUCHI, AZUMINO-SHI (JP)

(21) Appl. No.: 18/119,303

(22) Filed: Mar. 9, 2023

(30) Foreign Application Priority Data
Mar. 10, 2022 (JP) 2022-036900

(51) Int. Cl. B25J 9/16

(52) U.S. Cl. CPC B25J 9/163

(57) ABSTRACT

A robot teaching control method includes continuing to detect a position or an attitude of a robot while servo control of the robot is an ON state in a teaching mode for teaching of the robot, and, when receiving a teaching instruction after the servo control is switched from ON to OFF, storing last detected the position or the attitude as a teaching position or a teaching attitude. Further, the position or the attitude is detected at predetermined intervals.

The present application is based on, and claims priority from JP Application Serial Number 2022-036900, filed Mar. 10, 2022, the disclosure of which is hereby incorporated by reference herein in its entirety.

### BACKGROUND

### 1. Technical Field

The present disclosure relates to a robot teaching control method, a robot teaching apparatus, and a robot system.

### 2. Related Art

For example, JP-A-2003-311665 discloses a configuration teaching a robot using a teaching pendant (teaching apparatus). In the teaching pendant, an enable switch for safety is provided and, when the enable switch is pressed down, servo power is turned ON and, when the held down switch is released, the servo power is turned OFF. Accordingly, it is necessary for a worker to move the robot and give a teaching instruction with the enable switch of the teaching pendant held down.

However, if the servo power is turned OFF before the teaching instruction is given, the attitude of the robot may change under its own weight or the like. Accordingly, it is necessary for the worker to keep the servo power ON by continuing to hold down the enable switch until the teaching instruction is given. On this account, there is a problem that a burden on the worker tends to be heavier.

### SUMMARY

A robot teaching control method according to an aspect of the present disclosure includes continuing to detect a position or an attitude of a robot while servo control of the robot is an ON state in a teaching mode for teaching of the robot, and, when receiving a teaching instruction after the servo control is switched from ON to OFF, storing last detected the position or the attitude as a teaching position or a teaching attitude.

A robot teaching apparatus according to an aspect of the present disclosure is a robot teaching apparatus having a teaching control unit performing teaching control of a robot, and the teaching control unit continues to detect a position or an attitude of the robot while servo control of the robot is an ON state in a teaching mode for teaching of the robot, and, when receiving a teaching instruction after the servo control is switched from ON to OFF, stores last detected the position or the attitude as a teaching position or a teaching attitude.

A robot system according to an aspect of the present disclosure includes a robot, and a robot teaching apparatus performing teaching control of the robot, and the robot teaching apparatus continues to detect a position or an attitude of the robot while servo control of the robot is an ON state in a teaching mode for teaching of the robot, and, when receiving a teaching instruction after the servo control is switched from ON to OFF, stores last detected the position or the attitude as a teaching position or a teaching attitude.

### BRIEF DESCRIPTION OF THE DRAWINGS

FIG. 1 is a perspective view showing an overall configuration of a robot control system according to a preferred embodiment.

FIG. 2 is a plan view showing a robot teaching apparatus.

FIG. 3 is a flowchart showing a robot teaching control method.

### DESCRIPTION OF EXEMPLARY EMBODIMENTS

As below, a robot teaching control method, a robot teaching apparatus, and a robot system of the present disclosure will be explained in detail with reference to a preferred embodiment shown in the accompanying drawings.

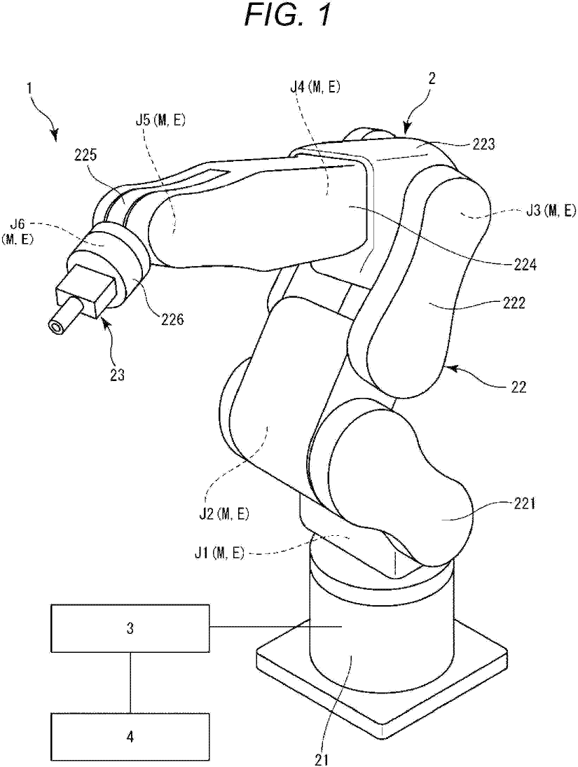

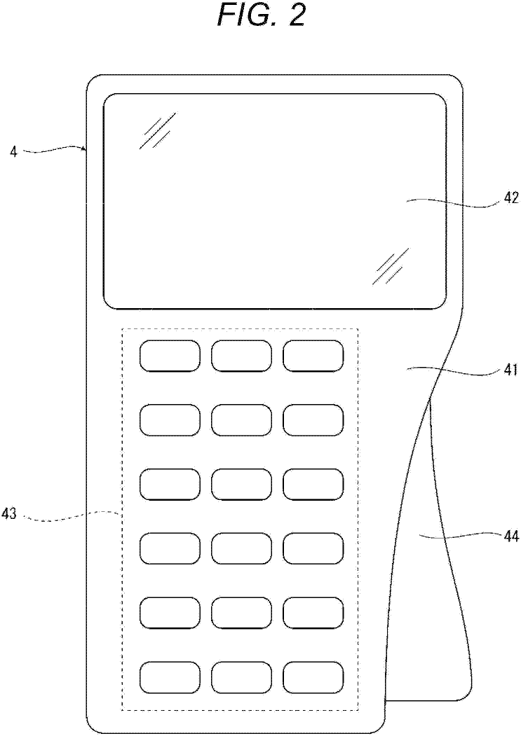

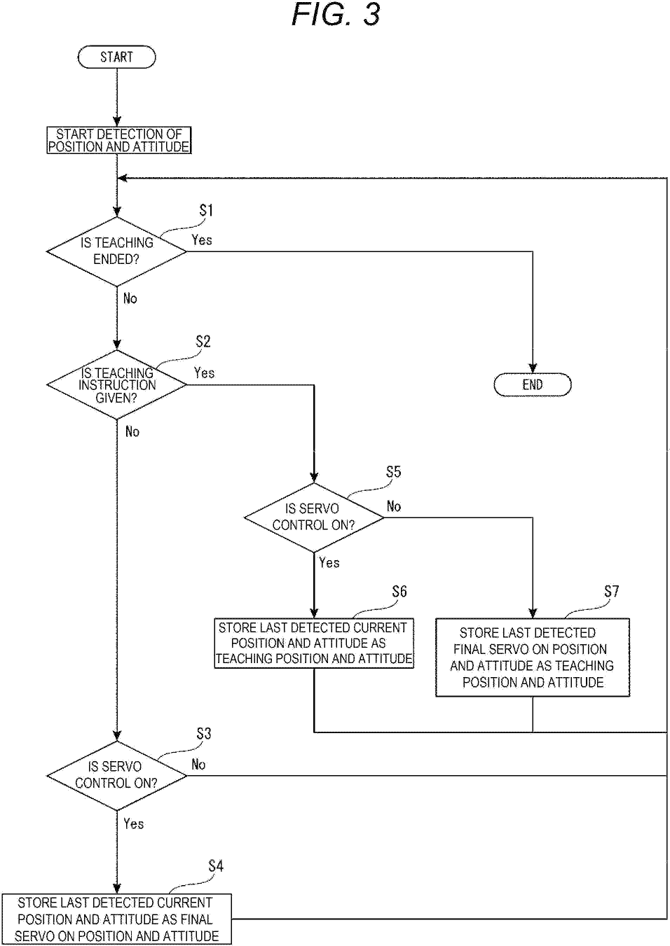

FIG. 1 is a perspective view showing an overall configuration of the robot control system according to the preferred embodiment. FIG. 2 is a plan view showing the robot teaching apparatus. FIG. 3 is a flowchart showing the robot teaching control method.

A robot system 1 shown in FIG. 1 has a robot 2, a robot control apparatus 3 controlling driving of the robot 2, and a robot teaching apparatus 4 teaching the robot 2.

The robot 2 is a robot performing work of feeding, removing, transport, assembly, etc. of precision apparatuses and components forming the precision apparatuses. However, the use of the robot 2 is not particularly limited. As shown in FIG. 1, the robot 2 is a six-axis robot and has a base 21, a robot arm 22 pivotably coupled to the base 21, and an end effector 23 coupled to the distal end portion of the robot arm 22.

The robot arm 22 is a robotic arm in which a plurality of arms 221, 222, 223, 224, 225, 226 are pivotably coupled and includes six joints J1 to J6. Of the joints, the joints J2, J3, J5 are bending joints and the joints J1, J4, J6 are twisting joints. Each of the joints J1, J2, J3, J4, J5, J6 includes a motor M as a drive source and an encoder E for detection of the amount of rotation of the motor M. The motors M of the respective joints J1, J2, J3, J4, J5, J6 are respectively independently driven, and thereby, the robot arm 22 may be moved in a desired trajectory.

As above, the robot 2 is explained, however, the configuration of the robot 2 is not particularly limited. For example, the robot 2 may be a scalar robot (horizontal articulated robot), a dual-arm robot, or the like. Further, the robot 2 may be fixed to a floor or the like or fixed to a vehicle such as an automated guided vehicle (AGV) to be movable.

The robot control apparatus 3 independently controls driving of the respective joints J1 to J6 and controls the robot 2 to perform predetermined work. Specifically, the robot control apparatus 3 independently controls driving of the respective joints J1 to J6 by servo control to feed back the detection results of the encoders E to driving of the motors M. The robot control apparatus 3 includes e.g., a computer and has a processor processing information, a memory communicably coupled to the processor, and an external interface. Further, various programs executable by the processor are stored in the memory and the processor may read and execute the various programs etc. stored in the memory.

The robot teaching apparatus 4 is coupled to the robot control apparatus 3 when teaching work of the robot 2 is performed. As shown in FIG. 2, the robot teaching apparatus 4 has e.g., a housing 41, a display screen 42, a button group 43, and an enable switch 44 placed in the housing 41. In the display screen 42, various kinds of information given to the worker, particularly, current position and attitude of the robot 2 are displayed. Further, the button group 3 includes arrow keys for jog operation of the robot 2, speed set keys for setting the movement speed at the jog operation, teaching position and attitude instruction keys for storage as teaching position and attitude, etc. The teaching position and attitude refer to e.g., the position and attitude of the robot used for work by the robot 2 and include at least one of a teaching position and a teaching attitude, and include both in the embodiment.

The enable switch 44 has e.g., three positions of non-pressed-down in which the switch is not pressed down, full-pressed-down in which the switch is fully pressed down, and halfway-pressed-down as an intermediate position of the non-pressed-down and the full-pressed-down. Only in the case of halfway-pressed-down, servo power is input and the servo control of the respective joints J1 to J6 is turned ON, and thereby, the jog operation (teaching operation) of the robot 2 is enabled. On the other hand, in the cases of non-pressed-down and full-pressed-down, the servo power is not input and the servo control of the respective joints J1 to J6 is turned OFF, and thereby, the jog operation of the robot 2 is disabled. That is, the robot 2 is stopped. According to the configuration, the robot 2 may be stopped by pressing down or release of the enable switch 44, and safe teaching work can be performed. Note that the configuration of the enable switch 44 is not particularly limited as long as ON/OFF of the servo control may be switched.

The robot teaching apparatus 4 includes e.g., a computer and has a processor processing information, a memory communicably coupled to the processor, and an external interface. Further, various programs executable by the processor are stored in the memory and the processor may read and execute the various programs etc. stored in the memory as a teaching control unit.

The configuration of the robot teaching apparatus 4 is not particularly limited. For example, at least one of the display screen 42, the button group 43, and the enable switch 44 may be separately formed. Or, the display screen 42 may be a touch screen and also serve as the button group 43.

Next, a robot teaching control method using the robot teaching apparatus 4 will be explained. The robot teaching control method includes continuing to detect the position and attitude of the robot 2 while servo control of the robot 2 is an ON state in a teaching mode for teaching of the robot 2 and, when receiving a teaching instruction from the worker after the servo control is switched from ON to OFF, storing last detected position and attitude as teaching position and attitude. As below, the specific explanation will be made with reference to the flowchart shown in FIG. 3. Note that the position and attitude include at least one of the position and the attitude of the robot 2, and include both in the embodiment.

When the teaching mode is started, the position and attitude of the robot 2 are detected at a predetermined frequency (at predetermined time intervals) and stored as current position and attitude. Note that all of the detected current position and attitudes may be stored or the current position and attitude may be updated to the latest current position and attitude. The position and attitude of the robot 2 may be detected based on the detection results of the encoders E of the respective joints J1 to J6. The following work is performed while the current position and attitude of the robot 2 are continued to be detected at the predetermined frequency in the above described manner. Note that the current position and attitude of the robot 2 are continued to be detected at the predetermined frequency, and thereby, variations in detection interval may be reduced and accurate teaching work may be performed. The method of detecting the position and attitude of the robot 2 is not limited to the method based on the detection results of the encoders E. For example, the position and attitude of the robot 2 may be detected based on motion command values for moving the robot 2.

First, as step S1, whether teaching is ended, that is, whether a command to end teaching is received from the worker is determined. When teaching is ended, the teaching mode is ended. On the other hand, when teaching is not ended, as step S2, whether a teaching instruction is received is determined. When the teaching instruction is not received, as step S3, whether servo control is the ON state is determined. When servo control is the ON state, as step S4, the last detected current position and attitude (the latest current position and attitude) are stored as final servo ON position and attitude, and the process returns to step S1. On the other hand, when servo control is an OFF state at step S3, the process returns to step S1.

When the teaching instruction is received at the above described step S2, as step S5, whether servo control is the ON state is determined. When servo control is the ON state, as step S6, the last detected current position and attitude (the latest current position and attitude) are stored as teaching position and attitude, and the process returns to step S1. On the other hand, when servo control is the OFF state, as step S7, the last detected final servo ON position and attitude (the latest final servo ON position and attitude) are stored as the teaching position and attitude, and the process returns to step S1.

According to the robot teaching control method, if servo control is the OFF state when the teaching instruction is received, not the last detected current position and attitude, but the last detected final servo ON position and attitude are set as the teaching position and attitude. Thereby, even when the worker finishes moving the robot 2 to the position and attitude desired to set as the teaching position and attitude by jog operation, then, before setting the position and attitude as the teaching position and attitude by pressing down the teaching instruction keys, releases the halfway-pressed-down of the enable switch 44 due to exhaustion, carelessness, or the like and servo control is turned OFF, correct teaching can be performed.

Specifically, when servo control is turned OFF after the worker finishes moving the robot 2 to the position and attitude desired to set as the teaching position and attitude, the power on the respective joints J1 to J6 is released (the applied forces are lost), and thereby, the position and attitude of the robot arm 22 may change due to the weight of its own, backlash of the gears, or the like of the robot arm 22. Therefore, if the last detected current position and attitude are set as the teaching position and attitude when servo control is OFF, the teaching position and attitude may be different from the position and attitude intended by the worker.

On the other hand, the last detected final servo ON position and attitude are the same as the position and attitude intended by the worker. Accordingly, the last detected final servo ON position and attitude are set as the teaching position and attitude, and thereby, the position and attitude intended by the worker may be set as a working point. As described above, according to the robot teaching control method of the embodiment, even when servo control is turned OFF before the teaching instruction is received, correct teaching may be performed. Therefore, the time to hold the enable switch 44 may be made as short as possible and the burden on the worker may be reduced. Further, even when servo control is turned OFF due to carelessness or the like, correct teaching may be performed.

Note that storing the teaching position and attitude is performed with respect to each of the joints J1 to J6. That is, the teaching position and attitude contain the amounts of rotation of the respective joints J1 to J6. Thereby, the teaching position and attitude may be correctly reproduced by adjustment of the respective joints J1 to J6 to the stored amounts of rotation. Further, not limited to that, but, for example, the teaching position and attitude may contain position and attitude of a tool center point as a control point in an orthogonal coordinate system with the base 21 as a reference position of the coordinate system. Note that the reference position of the orthogonal coordinate system may be set to any position.

Further, the robot teaching apparatus 4 has a function of selecting ON/OFF of servo control with respect to each of the joints J1 to J6. In other words, the apparatus has a function of selecting the joint to be kept with servo control remaining OFF even when the enable switch 44 is pressed down halfway. For example, there may be a joint not required to be moved depending on the motion required for the robot 2. In this case, when servo control of all joints J1 to J6 is uniformly turned ON, servo power is input to the joint not required to be moved and the power supplied to the part is wasted. Accordingly, when there is a joint not required to be moved, the worker selects the joint not to input servo power even when the enable switch 44 is pressed down halfway, and thereby, power-saving teaching work can be performed.

When ON/OFF of servo control is selected with respect to each of the joints J1 to J6, whether the last detected current position and attitude (latest current position and attitude) are stored or the last detected final servo ON position and attitude (the latest final servo ON position and attitude) are stored as the teaching position and attitude may be determined with respect to each of the joints J1 to J6. For example, when servo control of the joints J1 to J6 is the ON state at time t+1, servo control of the joint J1 is the OFF state and servo control of the joints J2 to J6 is the ON state at time t+2, and the teaching instruction is received at time t+3, the last detected final servo ON position and attitude, i.e., the position and attitude of the joint J1 at time t+1 are stored with respect to the joint J1 and the last detected current position and attitudes, i.e., the position and attitudes of the joints J2 to J6 at time t+3 are stored with respect to the joints J2 to J6.

As above, the robot system 1 is explained. The robot teaching control method performed in the robot system 1 includes continuing to detect the position and attitude as the position or the attitude of the robot 2 while servo control of the robot 2 is the ON state in the teaching mode for teaching of the robot 2 and, when receiving the teaching instruction after the servo control is switched from ON to OFF, storing the last detected position and attitude as the teaching position and attitude as the teaching position or the teaching attitude. According to the robot teaching control method, even when the worker finishes moving the robot 2 to the position and attitude desired to set as the teaching position and attitude, then, before setting the position and attitude as the teaching position and attitude, the servo control is turned OFF, correct teaching can be performed.

As described above, in the robot teaching control method, the position and attitude are detected at predetermined intervals. Thereby, variations in detection interval may be reduced and accurate teaching work may be performed.

As described above, in the robot teaching control method, the robot 2 has the plurality of joints J1 to J6 and stores the teaching position and attitude with respect to each of the plurality of joints J1 to J6. Thereby, the teaching position and attitude may be correctly reproduced by adjustment of the respective joints J1 to J6 to the stored amounts of rotation.

As described above, the robot teaching apparatus 4 of the robot system 1 is the robot teaching apparatus 4 having the teaching control unit performing teaching control of the robot 2, and the teaching control unit continues to detect the position and attitude as the position or the attitude of the robot 2 while servo control of the robot 2 is the ON state in the teaching mode for teaching of the robot 2 and, when receiving the teaching instruction after the servo control is switched from ON to OFF, stores the last detected position and attitude as the teaching position and attitude as the teaching position or the teaching attitude. Thereby, even when the worker finishes moving the robot 2 to the position and attitude desired to set as the teaching position and attitude, then, before setting the position and attitude as the teaching position and attitude, the servo control is turned OFF, correct teaching can be performed.

As described above, the robot system 1 has the robot 2 and the robot teaching apparatus 4 performing teaching control of the robot 2, and the robot teaching apparatus 4 continues to detect the position and attitude as the position or the attitude of the robot 2 while servo control of the robot 2 is the ON state in the teaching mode for teaching of the robot 2 and, when receiving the teaching instruction after the servo control is switched from ON to OFF, stores the last detected position and attitude as the teaching position and attitude as the teaching position or the teaching attitude. Thereby, even when the worker finishes moving the robot 2 to the position and attitude desired to set as the teaching position and attitude, then, before setting the position and attitude as the teaching position and attitude, the servo control is turned OFF, correct teaching can be performed.

As above, the robot teaching control method, the robot teaching apparatus, and the robot system of the present disclosure are explained based on the illustrated embodiments, however, the present disclosure is not limited to those. The configurations of the respective units may be replaced by any configurations having the same functions. Further, any other configuration may be added to the present disclosure.

What is claimed is:

1. A robot teaching control method comprising:
continuing to detect a position or an attitude of a robot while servo control of the robot is an ON state in a teaching mode for teaching of the robot; and
when receiving a teaching instruction after the servo control is switched from ON to OFF, storing last detected the position or the attitude as a teaching position or a teaching attitude.

2. The robot teaching control method according to claim 1, wherein
the position or the attitude is detected at predetermined intervals.

3. The robot teaching control method according to claim 1, wherein
the robot has a plurality of joints, and
the teaching position or the teaching attitude is stored with respect to each of the plurality of joints.

4. A robot teaching apparatus comprising,
one or more processors programmed to:
continue to detect a position or an attitude of a robot while servo control of the robot is an ON state in a teaching mode for teaching of the robot; and
store last detected the position or the attitude as a teaching position or a teaching attitude when receiving a teaching instruction after the servo control is switched from ON to OFF.

5. A robot system comprising:
a robot; and
a robot teaching apparatus performing teaching control of the robot,
the robot teaching apparatus
continuing to detect a position or an attitude of the robot while servo control of the robot is an ON state in a teaching mode for teaching of the robot, and
when receiving a teaching instruction after the servo control is switched from ON to OFF, storing last detected the position or the attitude as a teaching position or a teaching attitude.
